(19) United States
(12) Patent Application Publication
(10) Pub. No.: US 2009/0025426 A1
(43) Pub. Date: Jan. 29, 2009

(54) UV treated grey glass and method of making same

(75) Inventors: Ksenia A. Landa, Brownstown, MI (US); Leonid M. Landa, Brownstown, MI (US); Scott V. Thomsen, South Lyon, MI (US); Richard Hulme, Rochester Hills, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 11/878,316

(22) Filed: Jul. 23, 2007

(51) Int. Cl. C03C 21/00

(52) U.S. Cl. 65/30.13

(57) ABSTRACT

This invention relates to grey glass that is capable of achieving high light transmittance in the visible range in combination with good solar properties (e.g., reduced IR, UV and/or TS transmission), and/or a method of making the same. In certain example embodiments, the glass is treated with UV (ultraviolet) radiation in order to increase % FeO and/or CeO₂ content, thereby increasing the glass redox and improving solar performance of the glass. Such glass compositions are useful, for example and without limitation, in automotive windows (e.g., windshields, sidelites, backlites and sunroofs) and/or in architectural/residential window applications.

This invention relates to grey/green glass compositions and methods of making the same so as to achieve a high level of solar control. More particularly, this invention relates to grey/green glass compositions which are capable of achieving high light transmittance in the visible range and good solar properties (e.g., IR and UV reflectance/absorption). In certain example embodiments, the glass is treated with UV (ultraviolet) radiation in order to increase FeO and/or CeO₂ content thereby increasing the glass redox and improving solar performance of the glass. Such glass compositions are useful, for example and without limitation, in automotive windows (e.g., windshields, sidelites, backlites and sunroofs) and/or in architectural/residential window applications.

### BACKGROUND OF THE INVENTION

The automotive industry, for a number of years, has desired glass having grey color for automotive window applications. At the same time, it is also desirable for transmission in the UV (ultraviolet) and/or IR (infrared) ranges of the light spectrum to be minimized. While a visible transmittance of 70% or higher is not always required, it is safe to say that high visible transmittance (e.g., 65% or higher) in general is often desired. Accordingly, there exists a need for a glass which achieves high visible transmittance as well as adequate blocking of IR and/or UV rays.

A glass window or other glass article is said to have the desirable color “grey” when it has a dominant wavelength of from 435 nm to 570 nm (this dominant wavelength range defines the color “grey” herein). Moreover, grey glass preferably has an excitation purity (Pe) of less than or equal to about 4.5%.

While glass having “grey” color is often desirable, as explained above there sometimes also exists a need or desire to achieve certain levels of light transmission defined conventionally by:
Lta as visible light transmission,
UV as ultraviolet light transmission, and
IR as infrared light transmission.

Glass thickness ranges of from about 1-6 mm, more preferably from about 3-4 mm, are typically used when measuring the aforesaid characteristics. These thickness ranges are generally recognized as conventional thicknesses for glass sheets made by the float glass process, as well as recognized thickness ranges in the automotive industry.
Glass raw materials (e.g., silica, soda ash, dolomite, and/or limestone) typically include certain impurities such as iron. Iron may or may not be intentionally added. The total amount of iron present is expressed herein in terms of Fe₂O₃ in accordance with standard practice. However, typically, not all iron is in the form of Fe₂O₃. Instead, iron is usually present in both the ferrous state (Fe²⁺; expressed herein as FeO, even though all ferrous state iron in the glass may not be in the form of FeO) and the ferric state (Fe³⁺). Iron in the ferrous state (Fe²⁺; FeO) is a blue-green colorant and IR absorber, while iron in the ferric state (Fe³⁺) is a yellow-green colorant.

Classically formulated grey glasses, such as architectural, often include iron (e.g., less than 0.4% total iron) along with cobalt and nickel oxides. Unfortunately, while this type of glass may achieve satisfactory coloration in certain instances, it typically suffers from undesirable solar characteristics (e.g., not good with respect to UV and/or IR blockage).

Certain known green solar control float glasses are formulated so as to achieve desirable solar characteristics due in large part to their use of large quantities of total iron. Unfortunately, the green coloration of such glasses does not always harmonize well with certain exterior automotive paints and sometimes affects vehicle interiors when viewed through the glass, and large amounts of iron are not always desirable for glass processing.

U.S. Pat. No. 6,235,666 discloses a grey glass composition capable of achieving good solar performance characteristics, including the desirable color grey. In particular, U.S. Pat. No. 6,235,666 discloses a grey glass with a colorant portion including 0.5-0.8% total iron (expressed as Fe₂O₃), 0.5-3.0% Er₂O₃, and 0.0-1.0% TiO₂. While this is an excellent glass, it is sometimes undesirable in that it requires much of the very expensive erbium oxide (Er₂O₃). Thus, there exists a need in the art for a grey glass which can achieve desired grey color in combination with acceptable solar performance properties, without the need for much, if any, erbium.

U.S. Pat. No. 5,364,820 discloses a neutral grey glass. Example 1 of the '820 patent includes, for example, 0.403% total iron (expressed as Fe₂O₃), 0.41% cerium oxide, 0.31% titanium oxide, 23.2 ppm CoO, 7.6 ppm Se, and a glass redox of 0.243. This example of the '820 patent has a visible transmission of 70.3%, a total solar transmission (% TS) of 60.4%, and an infrared (IR) transmission (% IR) of 59%. Unfortunately, this example of the '820 patent is undesirable due to its very high IR transmittance (% IR) and also its very high total solar transmittance (% TS). In particular, it is often undesirable to allow this much IR radiation through the glass, especially in automotive applications and the like.

In view of the above, it is apparent that there exists a need in the art for a new glass composition which overcomes one or more of the above problems while achieving desired grey color and desired solar management property(ies) (e.g., UV and/or IR blocking functionality) of the particular industry in which it is to be used.

In certain example embodiments of this invention, there exists a need for an improved grey glass that is capable of achieving two, three, four or more of the following desirable solar control characteristics: (a) visible transmission (Tᵥᵢₛ) of at least about 60%, more preferably at least about 65%, and most preferably at least about 70%; (b) low UV transmittance of no more than about 35% or 33%, more preferably no more than about 30%, (c) low IR transmittance of no more than about 30% or 25%, more preferably no more than about 20%, and/or (d) low total transmitted solar energy TS of no more than about 46% or 43%, more preferably no more than about 41%, 40%, or even 39%.

### SUMMARY OF EXAMPLE EMBODIMENTS OF THE INVENTION

An example embodiment of this invention provides a grey glass having a dominant wavelength of from 435 nm to 570 nm and acceptable solar performance characteristics. The glass may include a colorant portion including from 0.35 to 0.90% total iron (expressed as Fe₂O₃) (more preferably from 0.40 to 0.90%; most preferably from 0.50 to 0.80%), part of which is present in the form of FeO (an IR absorber); from about 0.10 to 1.0% cerium oxide (more preferably from about 0.15 to 0.70%, even more preferably from about 0.20 to 0.60% cerium oxide, a glass redox of at least 0.30 (more preferably at least about 0.34; most preferably at least about 0.38,); optionally from 0 to 1% titanium oxide (more preferably from 0 to 0.75%; most preferably from 0.05 to 0.60%); optionally from 0.0001 to 0.25% cobalt oxide (more preferably from 0.0005 to 0.1%; most preferably from 0.001 to 0.004%); and optionally from 0.00001 to 0.25% Se (more preferably from 0.00005 to 0.05%; most preferably from 0.0001 to 0.001% Se). One, two or all three of colorants Ti, Co and/or Se may be omitted in certain example embodiments. In certain example embodiments, very small amounts of erbium oxide may also be present in certain example non-limiting instances.

The glass contains total iron (Fe₂O₃), part of which is present in the form of IR absorber FeO. Conventional float glass containing iron typically has a glass redox of from about 0.22 to 0.26, and thus not much ferrous iron FeO (and thus may suffer with respect to IR absorption). During the glass making process, CeO₂ may be added to the glass batch, and part of the CeO₂ transforms into Ce₂O₃ through reaction with iron as follows: FeO+CeO₂, Fe₂O₃+Ce₂O₃. This reaction causes solar performance of the glass to decrease, as the amounts of FeO and CeO₂ in the resulting glass decrease.

However, it has been found that treatment of the glass (after and/or during the float process where the glass is made) with UV radiation causes the reaction identified in the above equation to reverse, so that the amount of FeO and CeO₂ in the resulting glass increases, thereby improving solar performance of the glass (e.g., reducing UV, IR and/or TS transmission) while not significantly affecting visible transmission. This treatment with at least UV radiation also causes the glass redox to increase, e.g., the glass redox in the resulting glass may be at least about 0.30, more preferably at least about 0.34, and possibly at least about 0.38, thereby evidencing the increased FeO content in the glass.

The aforesaid glass compositions surprisingly allow for a high visible transmission to be achieved in combination with good IR and UV blocking functionality. For example, in certain example embodiments of this invention, the glass following UV treatment has a visible transmission (Tᵥᵢₛ) of at least about 60%, more preferably at least about 65%, and most preferably at least about 70%, and in combination with such a high visible transmission is characterized by one, two or three of: (i) low UV transmittance of no more than about 35%, more preferably no more than about 33%, and most preferably no more than about 30%, (ii) low IR transmittance of no more than about 30%, more preferably no more than about 25%, and most preferably no more than about 20%, and (iii) low total transmitted solar energy TS of no more than about 46%, more preferably no more than about 43%, and most preferably no more than about 41%, 40%, or even 39%.

In certain example embodiments of this invention, there is provided a method of making grey glass, the method comprising: providing a base glass portion comprising: SiO₂ 67-75%, Na₂O 10-20%, CaO 5-15%, MgO 0-7%, Al₂O₃ 0-7%, K₂O 0-7%, and a colorant portion comprising: total iron (expressed as Fe₂O₃) 0.35 to 0.90%, cerium oxide 0.05 to 1.0%, selenium 0.00001 to 0.25%, cobalt oxide 0.0001 to 0.25%, titanium oxide 0 to 1.0%, and treating the glass with UV radiation, so that the grey glass following said treating with UV radiation has a redox value (FeO/Fe₂O₃) of at least 0.30, a visible transmittance (Lta) of at least 60%, a dominant wavelength in the range of from 435 nm to 570 nm, an excitation purity (Pe) of no greater than 5.0%, an IR transmittance (% IR) of no greater than 30%, a UV transmittance (% UV) of no greater than 35%, and a total solar transmittance (% TS) of no greater than 46%.

In certain example embodiments of this invention, there is provided a method of making glass, the method comprising: providing a base glass portion comprising: SiO₂ 67-75%, Na₂O 10-20%, CaO 5-15%, MgO 0-7%, Al₂O₃ 0-7%, K₂O 0-7%, and a colorant portion comprising: total iron (expressed as Fe₂O₃) 0.35 to 0.90%, cerium oxide at least 0.05%, and treating the glass with UV radiation so that the glass following said treating with UV radiation has a redox value (FeO/Fe₂O₃) of at least 0.30, and an IR transmittance (% IR) of no greater than 30%.

In certain example embodiments of this invention, there is provided a grey glass comprising: a base glass portion comprising: SiO₂ 67-75%, Na₂O 10-20%, CaO 5-15%, MgO 0-7%, Al₂O₃ 0-7%, K₂O 0-7%, and a colorant portion comprising: total iron (expressed as Fe₂O₃) 0.35 to 0.90%, cerium oxide 0.05 to 1.0%, selenium 0.00001 to 0.25%, cobalt oxide 0.0001 to 0.25%, titanium oxide 0 to 1.0%, wherein the glass is treated with UV radiation so that after the UV radiation treatment the glass has a redox value (FeO/Fe₂O₃) of at least 0.30, a visible transmittance (Lta) of at least 60%, a dominant wavelength in the range of from 435 nm to 570 nm, an excitation purity (Pe) of no greater than 5.0%, an IR transmittance (% IR) of no greater than 30%, a UV transmittance (% UV) of no greater than 35%, and a total solar transmittance (% TS) of no greater than 46%.

### DETAILED DESCRIPTION OF CERTAIN EXAMPLE EMBODIMENTS OF THIS INVENTION

Grey or green colored glasses according to different embodiments of this invention may be used, for example, as windows in the automotive industry (e.g., windshields, backlites, sidelites, etc.), in architectural applications, and/or in other suitable applications.

Certain glasses according to this invention utilize soda-lime-silica glass as their base composition/glass, to which are added certain ingredients making up a colorant portion. An example soda-lime-silica base glass according to certain embodiments of this invention, on a weight percentage basis, includes the following basic ingredients:

TABLE 1
Example Base Glass

| Ingredient | Wt. % |
|---|---|
| SiO₂ | 67-75% |
| Na₂O | 10-20% |
| CaO | 5-15% |
| MgO | 0-7% |
| Al₂O₃ | 0-7% |
| K₂O | 0-7% |

Other minor ingredients, including various refining aids, such as salt cake, crystalline water and/or the like may also be included in the base glass. In certain embodiments, for example, glass herein may be made from batch raw materials silica sand, soda ash, dolomite, limestone, with the use of salt cake (SO₃) as a refining agent. Reducing agent(s) such as Si (metallic) (Si), silicon monoxide (SiO), sucrose, and/or carbon may also be used. Preferably, soda-lime-silica base glasses herein include by weight from about 10-15% Na₂O and from about 6-12% CaO. While a soda-lime-silica base glass set forth above is preferred in certain embodiments of this invention, this invention is not so limited. Thus, other base glasses (e.g., borosilicate glass) may instead be employed in alternative embodiments.

In certain example embodiments of this invention, to the base glass (e.g., see Table 1 above) a colorant portion is added which causes the resulting glass to be grey in color (i.e., dominant wavelength of from 435 nm to 570 nm). In certain example embodiments of this invention, the colorant portion that is added to the base glass is substantially free of nickel (i.e., no more than about 0.0010% Ni and/or NiO), and is characterized as set forth in Table 2 below (in terms of weight percentage of the total glass composition in the final glass product). The colorant portions in different embodiments of this invention may either comprise the materials in Table 2 below, or consist essentially of the materials in Table 2 below.

TABLE 2
Example Colorant Portion

| Ingredient | Preferred | More Preferred | Most Preferred |
|---|---|---|---|
| Total iron (expressed | 0.35 to 0.90% | 0.40 to 0.90% | 0.50 to 0.80% |
| as Fe₂O₃): | | | |
| Cerium oxide | 0.10 to 1.0% | 0.15 to 0.70% | 0.20 to 0.60% |
| (total - all forms): | | | |
| Selenium (Se): | 0.00001-0.25% | 0.00005-0.05% | 0.0001-0.001% |
| Cobalt oxide (e.g., | 0.0001-0.25% | 0.0005-0.1% | 0.001-0.004% |
| Co₃O₄): | | | |
| Titanium Oxide: | 0 to 1.0% | 0 to 0.75% | 0.05 to 0.60% |
| (e.g., TiO₂) | | | |
| Glass Redox | >=0.30 | >=0.34 | >=0.38 |
| (FeO/Fe₂O₃): | | | |

However, it should be appreciated that small amounts of other materials (e.g., refining aids, melting aids, and/or impurities) may be present in the glass such as chromium, manganese, molybdenum, tin, chlorine, zinc, zirconium, Si, sulfur, fluorine, lithium and strontium, without taking away from the purpose(s) and/or goal(s) of the oxide (invention. Moreover, in certain example instances, from 0 to 0.3% erbium oxide (sometimes from 0.00001 to 0.2%) may be provided in the glass. Also, the total amount of cerium oxide may be as low as about 0.05%, or even 0.01%, in certain example instances.

The aforesaid colorant portion allows grey color to be achieved, while at the same time (after the UV treatment) maintaining satisfactory solar performance properties including high visible transmission coupled with low IR (infrared) and low UV (ultraviolet) transmittance. In particular, in certain example embodiments the colorant portion allows improved IR absorption (a type of solar performance) by having a rather high glass redox; and thus a high amount of IR absorber FeO relative to total iron. However, if the blue color resulting from the high redox (i.e., the relatively high amount of FeO) is not adequately compensated for, then the glass will no longer be grey. Selenium and cobalt may be used to compensate for this blue/green and yellow/green coloration caused by the iron in the ferric and ferrous states. The glass may be green colored in alternative embodiments of this invention.

Moreover, cerium oxide is added for the purpose of improving UV blockage. Typically, during making of the glass, cerium oxide functions as an oxidizer thereby causing FeO in the batch to oxidize. In particular, part of the CeO₂ added to the glass batch transforms into Ce₂O₃ through reaction with iron in accordance with the following reaction: FeO+CeO_{2→}Fe₂O₃+Ce₂O₃. This reaction causes solar performance of the glass to decrease, as the amounts of FeO and CeO₂ in the resulting glass decrease. In other words, unfortunately, significant oxidation of FeO in the batch is undesirable because this reduces IR blockage (i.e., it causes % IR to increase) by lowering the glass redox. We do not want too much oxidation to occur, because a low % IR (i.e., low IR transmittance) is desired.

In order to compensate for the oxidizing function of cerium oxide, and to allow for low % IR in combination with low % UV, low % TS, high visible transmission, and desired grey color in the resulting glass, it has surprisingly been found that treatment of the glass (after and/or during the float process where the glass is made) with UV radiation causes the reaction identified above to reverse and/or stop, so that the amount of FeO and CeO₂ in the resulting glass increases, thereby improving solar performance of the glass (e.g., reducing UV, IR and/or TS transmission) while not significantly affecting visible transmission. This UV treatment also causes the glass redox to increase, e.g., the glass redox in the resulting glass may be at least about 0.30, more preferably at least about 0.34, and possibly at least about 0.38, thereby evidencing the increased FeO content in the glass. The UV treatment of the glass or hot glass ribbon may be performed by using one or more UV generating lamps or the like to direct UV radiation at the glass or hot glass ribbon. Other types of UV treatment may also be used, for any suitable period of time, in certain example embodiments of this invention. In certain example embodiments of this invention, the UV treatment is of sufficient magnitude and time to cause the glass redox to increase at least about 2%, more preferably at least about 4%, even more preferably at least about 6% or even at least about 10%, 15%, 20%, 30%, or 40% in certain example instances, compared to if the UV treatment was not performed. In certain example embodiments, the resulting effect is stable or substantially stable at temperatures from normal/ambient up to about 500 degrees C.

In certain example embodiments herein, glasses may be characterized by one or more of the optical characteristics, following the UV treatment, set forth below when measured at a nominal thickness of from 1-6 mm, more preferably from about 3-4 mm (about 3 or 4 mm may be used for a reference thickness in certain example non-limiting embodiments.) In Table 3, color values a*, b* and L* are in accordance with Ill. D65, 10 degree observer, as is known in the art.

TABLE 3
Example Optical Characteristics

| | | | Most |
|---|---|---|---|
| Characteristic | Preferred | More Preferred | Preferred |
| Lta (visible transmittance): | >=60% | >=65% | >=70% |
| IRₜᵣₐₙₛₘᵢₛₛᵢₒₙ (% IR): | <=30% | <=25% | <=20% |
| UVₜᵣₐₙₛₘᵢₛₛᵢₒₙ (% UV): | <=35% | <=33% | <=30% |
| % TS (total solar): | <=46% | <=43% | <=41 or 39% |
| Dominant Wavelength (λ): | 435-570 nm | 470-555 nm | 480-520 nm |
| Excitation Purity (Pe): | <=5.0 | <=4.5 | <=3.0 |
| a* (Ill. D65, 10 deg): | −8 to +2 | −4 to +1 | −2 to 0 |
| b* (Ill. D65, 10 deg): | −5 to +5 | −3 to +3 | −1.5 to +1.5 |
| L* (Ill. D65, 10 deg.): | 80 to 95 | 84 to 91 | 85 to 90 |

The “grey” color achieved by glasses according to certain example embodiments of this invention is a function of dominant wavelength and excitation purity. Grey glass herein typically has a dominant wavelength of from 435 nm to 570 nm, and an excitation purity (Pe) of no greater than about 5.0 or 4.5%. Moreover, it can be seen from the above that desired grey coloration and high visible transmission have surprisingly been coupled with low IR and low UV transmittance values.

The total amount of iron present in the glass, and thus in the colorant portion thereof, is expressed herein in terms of Fe₂O₃ in accordance with standard practice. This, however, does not imply that all iron is actually in the form of Fe₂O₃. Likewise, the amount of iron in the ferrous state is reported herein as FeO, even though all ferrous state iron in the glass may not be in the form of FeO. The proportion of the total iron in the ferrous state (i.e., FeO) is used to determine the redox state of the glass (i.e., glass redox), which is expressed as the ratio FeO/Fe₂O₃, which is the weight percentage (%) of iron in the ferrous state (expressed as FeO) divided by the weight percentage (%) of total iron (expressed as Fe₂O₃). Thus, Fe₂O₃ herein means total iron and FeO means iron in the ferrous state. Iron in the ferrous state (Fe²⁺; FeO) is a blue-green colorant, while iron in the ferric state (Fe³⁺) is a yellow-green colorant. According to certain embodiments of this invention, the colorant portion of the glass composition herein is characterized by a glass redox value (i.e., FeO/Fe₂O₃) of at least 0.30, more preferably at least 0.34 and most preferably at least 0.38 or even possibly at least about 0.40 or 0.42 in certain instances. It is noted that in different embodiments of this invention iron may be added to the glass batch during the manufacturing process in any suitable form (e.g., via rouge and/or melite).

Glass according to certain embodiments of this invention is often made via the known float process in which a tin bath is utilized. It will thus be appreciated by those skilled in the art that as a result of forming the glass on molten tin in certain example embodiments, small amounts of tin or tin oxide may migrate into surface areas of the glass on the side that was in contact with the tin bath during manufacture (i.e., typically, float glass may have a tin oxide concentration of 0.05% or more (wt.) in the first few microns below the surface that was in contact with the tin bath).

Se (selenium) may be present in the colorant portion in different embodiments, and acts as a pink colorant. While selenium often combines with iron as iron selenide (FeSe) in glass to produce brown color, selenium is referred to in the colorant portion herein as “Se” which is meant to include, for example, its state as Se as well as its other states in glass such as FeSe.

Cobalt (Co) is a blue colorant. It is believed that much of the cobalt in the glass is in the oxide state of CO₃O₄. However, other oxide states of CoO are also possible in glasses according to this invention. Thus, unless expressly stated to the contrary, the terms “cobalt oxide”, “CoO” and “CO₃O₄” as used herein include not only cobalt in this/these particular oxide state(s), but also include(s) cobalt which may be present in other oxide or non-oxide state(s).

Erbium (Er) is a pink colorant. In certain embodiments of this invention, glasses herein are free of erbium (and erbium oxide). However, in other example embodiments, small amounts of erbium may be used as mentioned above. In such cases, it is believed that much of the erbium in the glass is in the oxide state of Er₂O₃. However, other oxide states of erbium are also possible in glasses according to this invention. Thus, unless expressly stated to the contrary, the terms “erbium oxide” and “Er₂O₃” as used herein include not only erbium in this/these particular oxide state(s), but also include(s) erbium which may be present in other oxide or non-oxide state(s).

Cerium oxide is used primarily herein as a UV absorber, but is referred to as a colorant since it acts as a chemical decolorizer as will be explained below. Cerium, for example, may be added to the batch in the form of CeO₂, and may take the form of Ce₂O₃ and/or CeO₂ (especially due to the UV treatment) (or any other suitable form) in the final glass. As explained above, the UV treatment causes more of the cerium oxide in the resulting glass to be in the form of CeO₂.

Titanium oxide is an optional colorant, which also performs UV absorption functionality, in certain example embodiments of this invention. Numerous oxide states of Ti are possible. Thus, unless expressly stated to the contrary, the terms “titanium oxide” and “TiO₂” as used herein include not only Ti in this/these particular oxide state(s), but also include(s) Ti which may be present in other oxide or non-oxide state(s).

Terms used herein are known in the glass art. For example, luminous transmittance (Lta) (2 degree observer) is understood in the art, and is used herein in accordance with its known meaning. This term is also known as Ill. A visible transmittance (380-780 nanometers inclusive), and its measurements are made in accordance with CIE Publication 15.2 (1986)). The terms, and characteristics, of ultraviolet light transmittance (% UV), infrared energy transmittance (% IR), total solar transmittance (% TS), dominant wavelength (DW) and excitation purity (i.e. % “purity”, or Pe) are also well understood terms in the art, as are their measurement techniques. Such terms are used herein, in accordance with their well known meaning, e.g., see U.S. Pat. No. 5,308,805. In particular, ultraviolet transmittance (% UV) may be measured using Parry Moon Air Mass=2 (300-400 nm inclusive, integrated using Simpson's Rule at 10 nm intervals). IR transmittance may be conventionally measured using Simpson's Rule and Parry Moon Air Mass=2 over the wavelength range 800-2100 nm inclusive at 50 nm intervals. % TS (300-2,100 nm) is also known in the art. Dominant wavelength (DW) may be calculated and measured conventionally in accord with the aforesaid CIE Publication 15.2 (1986) and ASTM: E 308-90. The term “dominant wavelength” includes both the actual measured wavelength and, where applicable, its calculated complement. Excitation purity (Pe or % “purity”) may be measured conventionally in accordance with CIE Publication 15.2 (1986) and ASTM: E 308-90.

Once given the above disclosure many other features, modifications and improvements will become apparent to the skilled artisan. Such features, modifications and improvements are therefore considered to be a part of this invention, the scope of which is to be determined by the following claims:

What is claimed is:

1. A method of making grey glass, the method comprising:
providing a base glass portion comprising:

| Ingredient | wt. % |
|---|---|
| SiO₂ | 67-75% |
| Na₂O | 10-20% |
| CaO | 5-15% |
| MgO | 0-7% |
| Al₂O₃ | 0-7% |
| K₂O | 0-7% |

and a colorant portion comprising:

| | |
|---|---|
| total iron (expressed as Fe₂O₃) | 0.35 to 0.90% |
| cerium oxide | 0.05 to 1.0% |
| selenium | 0.00001 to 0.25% |
| cobalt oxide | 0.0001 to 0.25% |
| titanium oxide | 0 to 1.0% |

treating the glass with UV radiation, so that the grey glass following said treating with UV radiation has a redox value (FeO/Fe₂O₃) of at least 0.30, a visible transmittance (Lta) of at least 60%, a dominant wavelength in the range of from 435 nm to 570 nm, an excitation purity (Pe) of no greater than 5.0%, an IR transmittance (% IR) of no greater than 30%, a UV transmittance (% UV) of no greater than 35%, and a total solar transmittance (% TS) of no greater than 46%.

2. The method of claim 1, wherein after said treating with UV radiation the glass has a redox value (FeO/Fe₂O₃) of at least 0.34, a visible transmittance (Lta) of at least 65%, an IR transmittance (% IR) of no greater than 25%, and a UV transmittance (% UV) of no greater than 33%.

3. The method of claim 1, wherein said dominant wavelength and excitation purity are measured at a nominal thickness of the glass of anywhere from 3 mm to 4 mm, and wherein after said treating with UV radiation the glass has a dominant wavelength of from 480 to 520 nm and an excitation purity (Pe) of no greater than 3.0%.

4. The method of claim 1, wherein the glass is substantially free of nickel.

5. The method of claim 1, wherein after said treating with UV radiation the glass has a redox value (FeO/Fe₂O₃) of at least 0.34.

6. The method of claim 1, wherein after said treating with UV radiation the glass has a redox value (FeO/Fe₂O₃) of at least 0.38.

7. The method glass of claim 1, wherein after said treating with UV radiation said colorant portion comprises:

| | |
|---|---|
| total iron (expressed as Fe₂O₃) | 0.40 to 0.90% |
| cerium oxide | 0.10 to 1.0% |
| selenium | 0.00005 to 0.05% |
| cobalt oxide | 0.0005 to 0.1%. |

8. The method of claim 1, wherein after said treating with UV radiation the glass has a visible transmission Lta of at least about 65%.

9. The method of claim 1, wherein after said treating with UV radiation the glass has a color characterized as follows when measured according to Ill. D65, 10 degree observer:

| | |
|---|---|
| a* | from −4 to +1 |
| b* | from −3 to +3 |
| L* | from 80 to 95. |

10. The method of claim 1, wherein after said treating with UV radiation the glass has a visible transmittance (Lta) of at least 70%.

11. The method of claim 1, wherein after said treating with UV radiation the glass has an IR transmittance (% IR) of no greater than 25%.

12. The method of claim 1, wherein after said treating with UV radiation the glass has an IR transmittance (% IR) of no greater than 20%.

13. The method of claim 1, wherein after said treating with UV radiation the glass has a UV transmittance (% UV) of no greater than 33%.

14. The method of claim 1, wherein after said treating with UV radiation the glass has a UV transmittance (% UV) of no greater than 30%.

15. The method of claim 1, wherein said treating with UV radiation is of sufficient magnitude and time to cause the glass redox to increase at least about 10%.

16. The method of claim 1, wherein said treating with UV radiation is of sufficient magnitude and time to cause the glass redox to increase at least about 20%.

17. The method of claim 1, wherein said treating with UV radiation is of sufficient magnitude and time to cause the glass redox to increase at least about 30%.

18. A method of making glass, the method comprising:
providing a base glass portion comprising:

| Ingredient | wt. % |
|---|---|
| SiO₂ | 67-75% |
| Na₂O | 10-20% |
| CaO | 5-15% |
| MgO | 0-7% |
| Al₂O₃ | 0-7% |
| K₂O | 0-7% |

and a colorant portion comprising:

| | |
|---|---|
| total iron (expressed as Fe₂O₃) | 0.35 to 0.90% |
| cerium oxide | at least 0.05% |

treating the glass with UV radiation, so that the glass following said treating with UV radiation has a redox value (FeO/Fe₂O₃) of at least 0.30, and an
IR transmittance (% IR) of no greater than 30%.

19. The method of claim 18, wherein after said treating with UV radiation the glass has a UV transmittance (% UV) of no greater than 35%.

20. The method of claim 18, wherein after said treating with UV radiation the glass has a total solar transmittance (% TS) of no greater than 46%.

21. The method of claim 18, wherein after said treating with UV radiation the glass has a redox value (FeO/Fe₂O₃) of at least 0.34, a visible transmittance (Lta) of at least 65%, an IR transmittance (% IR) of no greater than 25%, and a UV transmittance (% UV) of no greater than 33%.

22. The method of claim 18, wherein after said treating with UV radiation the glass has a redox value (FeO/Fe₂O₃) of at least 0.34.

23. The method of claim 18, wherein said treating with UV radiation is of sufficient magnitude and time to cause the glass redox to increase at least about 10%.

24. The method of claim 18, wherein said treating with UV radiation is of sufficient magnitude and time to cause the glass redox to increase at least about 30%.

25. A grey glass comprising:
a base glass portion including:

| Ingredient | wt. % |
|---|---|
| SiO₂ | 67-75% |
| Na₂O | 10-20% |
| CaO | 5-15% |
| MgO | 0-7% |
| Al₂O₃ | 0-7% |
| K₂O | 0-7% |

a colorant portion comprising:

| | |
|---|---|
| total iron (expressed as Fe₂O₃) | 0.35 to 0.90% |
| cerium oxide | 0.05 to 1.0% |
| selenium | 0.00001 to 0.25% |
| cobalt oxide | 0.0001 to 0.25% |
| titanium oxide | 0 to 1.0% |

wherein the glass is exposed to UV radiation so that after the glass has been exposed to the UV radiation the glass has a redox value (FeO/Fe₂O₃) of at least 0.30, a visible transmittance (Lta) of at least 60%, a dominant wavelength in the range of from 435 nm to 570 nm, an excitation purity (Pe) of no greater than 5.0%, an IR transmittance (% IR) of no greater than 30%, a UV transmittance (% UV) of no greater than 35%, and a total solar transmittance (% TS) of no greater than 46%.
